(19) United States
(12) Patent Application Publication
(10) Pub. No.: US 2013/0100982 A1
(43) Pub. Date: Apr. 25, 2013

(54) Monitoring the temperature change in the charging cable

(71) Applicants: Stephan Gase, Tiefenbronn (DE); Jochen Fassnacht, Calw (DE); Dragan Mikulec, Erlangen (DE); Philipp Morrison, Muenchen (DE)

(72) Inventors: Stephan Gase, Tiefenbronn (DE); Jochen Fassnacht, Calw (DE); Dragan Mikulec, Erlangen (DE); Philipp Morrison, Muenchen (DE)

(21) Appl. No.: 13/636,414

(22) PCT Filed: Mar. 15, 2011
(86) PCT No.: PCT/EP2011/053829

§ 371 Date: Nov. 21, 2012

(30) Foreign Application Priority Data
Mar. 30, 2010 (DE) 102010003470.3

(51) Int. Cl. G01N 25/00

(52) U.S. Cl. CPC G01N 25/00
USPC 374/45

(57) ABSTRACT

A method for determining the temperature change of a feeder cable of a charging device in that, in a first task, the electromagnetic input pulse is coupled into the feeder cable, the electromagnetic input pulse being able to be reflected in the feeder cable and the reflected portion returning to the charging device as reflected electromagnetic output pulse; in a second task, the pulse shape of the reflected electromagnetic output pulse is determined; in a third task, the pulse shape of the reflected electromagnetic output pulse is compared to a reference pulse shape of the reflected reference pulse; in a fourth task, the temperature change is determined by comparing the two pulse shapes.

### FIELD OF THE INVENTION

The present invention relates to a method and device for monitoring a temperature change in a charging cable.

BACKGROUND INFORMATION

It is believed that there are different methods for determining temperature changes in feeder cables, such as the method in US 2006/0289463 A1, for example. Knowledge of the change in temperature in feeder cables is required for the charging process of electrical vehicles, for instance.

Such processes for determining temperature changes in feeder cables have the disadvantage that changes in the temperature are measured by sensors that are situated in a certain location of the feeder cable and which record the changes in temperature only at this particular location. For example, if an electrical vehicle is charged from the public power grid via the home terminal, then high charging currents are generated in the feeder cables over a longer period of time. Since homogeneous infrastructures for the private power grid do not exist and feeder cables also differ with regard to cable diameter, installation type and safeguards for the cables, for example, it is possible that at high currents in the feeder cables, locally excessive heat develops, which poses a fire and injury hazard. Furthermore, feeder cables of the public power grid are frequently installed inside the walls of buildings and thus not accessible for measurements by sensors. It is therefore believed that sensors cannot be used for detecting temperature changes at all points in the feeder cable.

### SUMMARY OF THE INVENTION

The method according to the present invention having the characteristic features described herein is believed to have the advantage that it allows the feeder cables of a charging device to be monitored for temperature changes and that temperature changes are detectable in all of the feeder cables.

For this purpose, in a first step according to the exemplary embodiments and/or exemplary methods of the present invention, an electronics system of the charging device generates an electromagnetic input pulse, which is coupled into the feeder cable of the charging device. This input pulse is reflected at high temperature locations in the feeder cable, and the reflected portion returns to the charging device as reflected electromagnetic output pulse. In a second step, the pulse shape of the reflected electromagnetic output pulse is determined and compared to a reference pulse shape of the reflected reference pulse in a third step. The temperature change is finally ascertained in a fourth step, by comparing the output pulse shape to the reference pulse shape. If this method is employed in charging devices for charging batteries in electrical vehicles, the charging process may advantageously be carried out using the maximally possible current, without the need to take local restrictions of the home power supply network into account. The charging process is able to be performed in optimal manner, independently of the locally available infrastructure of the power supply system in the home.

Advantageous further developments of the method described in herein are rendered possible by the measures delineated in the further descriptions herein.

At the beginning of the charging process, the pulse shape of the reflected electromagnetic output pulse is advantageously stored in the charging device as reference pulse shape, since the temperature is low at the beginning and then rises in the course of the charging process. The reference pulse shape thus is assigned to the temperature of the feeder cable at the beginning of the charging process, which usually is the ambient temperature, and may advantageously be utilized to determine the temperature change of the current feeder cable based on the comparison of the reflected output pulse shape and the reference pulse shape.

In addition, the pulse duration and pulse amplitude or the pulse spectrum obtained from a spectral analysis are advantageously used as measure for the pulse shape. Because of the temperature change in the feeder cable, the pulse shape of the electromagnetic input pulse undergoes changes after being reflected in the current feeder cable, the changes relating to the pulse duration, pulse amplitude and pulse spectrum, which are advantageously utilized as a measure for the temperature change. A first possibility for determining the temperature change in the feeder cable is a comparison of the pulse duration and/or the pulse amplitude of the reflected electromagnetic output pulse to the electromagnetic reference pulse. Another possibility for determining the temperature change in the feeder cable is a comparison of the pulse spectrum, obtained from a spectral analysis, of the reflected electromagnetic output pulse to the electromagnetic reference pulse.

The electromagnetic input pulse coupled into the feeder cable in order to determine the temperature change is advantageously a low-energy pulse and has a voltage in a voltage range that is less than or equal to 30 Volt (DC). On the one hand, this ensures that the electronics system in the charging device and the electronics system situated on the feeder cable will not be damaged. On the other hand, it is ensured that the low-energy electromagnetic input pulses are able to be generated in an inexpensive and simple manner.

The in-coupling of the input pulses into the feeder cable is advantageously carried out using a sequence (pattern) that varies over time and does not repeat itself within the time period required for the reflection. An electromagnetic output pulse reflected in the feeder cable is therefore able to be clearly allocated to an input pulse, coupled into the feeder cable, from which it was created as a result of the reflection in the feeder cable. Varying the chronological sequence of the input pulses advantageously provides information about the propagation times and the location of the reflection of the input pulses.

If the comparison of the shape of the reflected electromagnetic output pulse with the shape of the reference pulse indicates that a defined temperature range is exceeded during the charging process, then the charging current is advantageously reduced. The fire and injury hazards during the charging operation are therefore able to be reduced.

The exemplary embodiments and/or exemplary methods of the present invention will now be explained in greater detail in the following text with the aid of exemplary embodiments and the corresponding drawings.

### BRIEF DESCRIPTION OF THE DRAWINGS

FIG. 1 schematically shows the charging process of an electrical vehicle as an exemplary embodiment of the present invention.

FIG. 2 shows a schematic representation of an input pulse shape and a reflected electromagnetic output pulse shape plotted over the time.

FIG. 3 schematically illustrates an example of a possible spectrum of an input pulse and a reflected electromagnetic output pulse plotted over the frequency.

### DETAILED DESCRIPTION

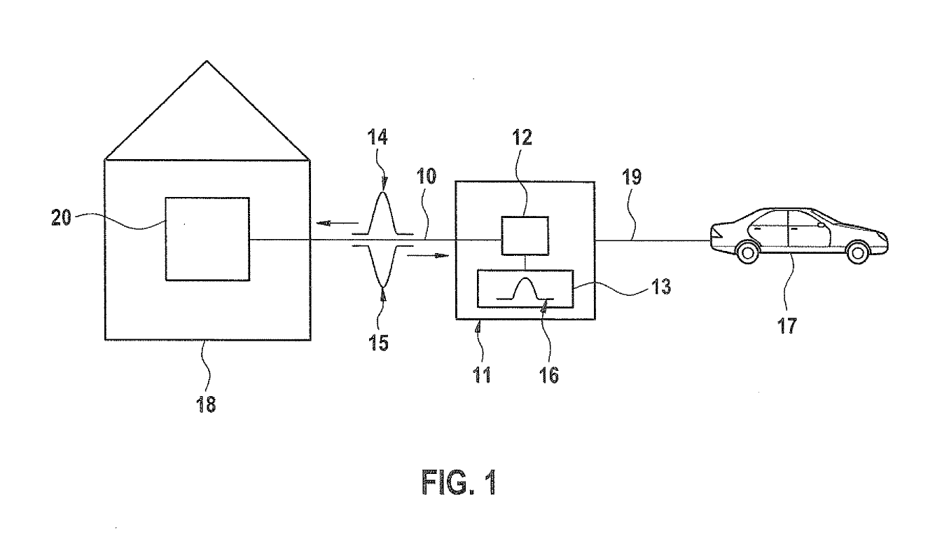

FIG. 1 schematically illustrates the charging process of a battery (the battery is not explicitly shown) in a vehicle 17, e.g., an electrical vehicle, in the form of an exemplary embodiment of the present invention. A charging device 11 used for the charging process includes an electronics system 12 for generating a low-energy electromagnetic input pulse 14 in a voltage range that lies below or is equal to 30V (DC); it also includes an evaluation electronics system 13 for determining a pulse shape. On one side, charging device 11 is connected to current supply 20 of a house 18 via a feeder cable 10, and on the other side it is connected to an electrical vehicle 17 by way of a feeder cable 19. Input pulse 14 coupled into feeder cable 10 in the first method step is reflected at locations where high temperatures exist in feeder cable 10, and the reflected portion returns to charging device 11 as reflected electromagnetic output pulse 15. Input pulse 14 is reflectable in feeder cable 10, for instance at locations having high temperatures, where the Ohmic resistance of the feeder cable increases. The temperature change is a result of excessive current intensities in feeder cable 10.

At the beginning of the charging process, the temperature in feeder cable 10 poses no fire or injury hazard attributable to overheating. The pulse shape of a first reflected electromagnetic output pulse 15 is stored in charging device 11 as reference pulse shape 16. Reference pulse shape 16 thus constitutes a reference for a reflected output pulse shape at which the temperature of the feeder cables lies in a safe range. This reference pulse shape 16 thus is assigned to the temperature of the feeder cables at the beginning of the charging process and may be used as reference scale for the output pulse shapes reflected during the charging process, so that a potential change in temperature of feeder cable 10 may be determined by comparing them to the reference pulse shape. A low-energy pulse, which has a voltage in a voltage range of less than or equal to 30 Volt, is used as electromagnetic input pulse.

The incoupling of input pulses 14 may additionally take place in chronological order, so that reflected output pulse 15 arriving in charging device 11 is able to be allocated to input pulse 14 from which is was created via the reflection in feeder cable 10. The chronological sequence of coupled input pulses 14 takes the form of different patterns, which do not repeat within the time period required for the reflection. If the comparison of the pulse shapes of reflected output pulse 15 and reference pulse 16 indicates that a defined temperature range is exceeded in the charging process, then the charging current is reduced.

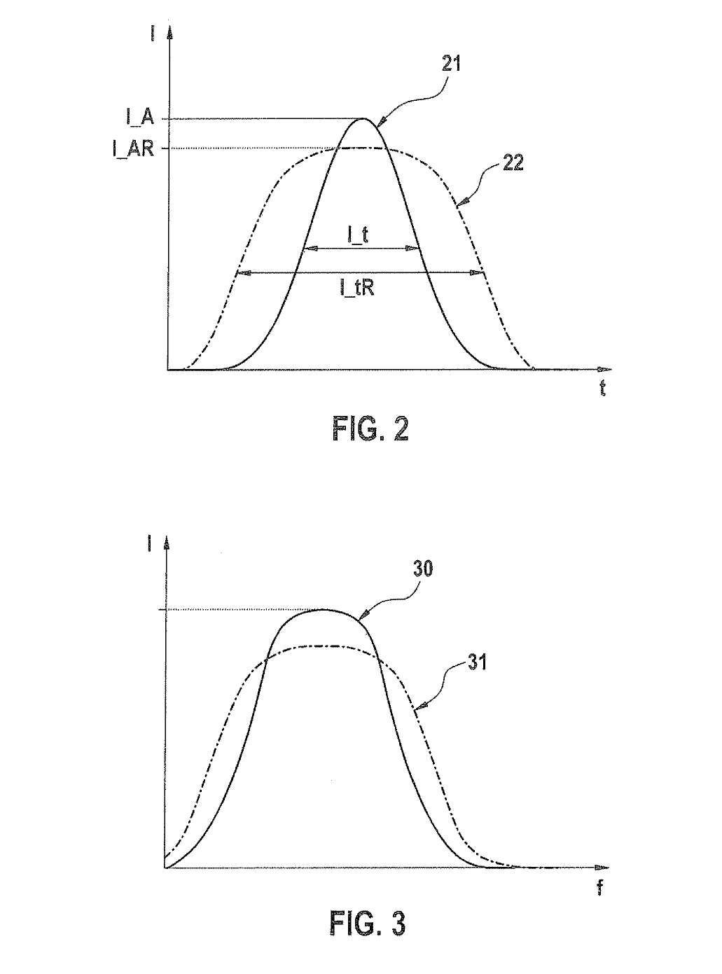

FIG. 2 schematically shows an example of a reference pulse shape 21 plotted over time t, and a possible reflected electromagnetic output pulse shape 22. Reference pulse shape 21 has a reference pulse amplitude I_A and a reference pulse duration I_t. Reflected output pulse shape 22 has an output pulse amplitude I_AR and an output pulse duration I_tR. Input pulse 14 coupled into feeder cable 10 is reflectable in feeder cable 10. The reflected portion returns to charging device 11 as reflected electromagnetic output pulse 15. The reflection of input pulse 14 inside feeder cable 10 may take place at locations where high temperatures are found, which cause a rise in the Ohmic resistance of feeder cable 10, and are a result of excessive current intensities in feeder cable 10. At the beginning of the charging process, the temperature of feeder cable 10 does not pose a fire or injury hazard. In this case the pulse shape of one of the first suitable reflected electromagnetic output pulses 15 is stored in charging device 11 as reference pulse shape 16. Electronic system 13 then uses this reference pulse shape 16 to determine reference pulse duration I_t and reference pulse amplitude I_A. In the course of the charging process reflected electromagnetic output pulse 15 arriving at charging device 11 is utilized for determining output pulse duration I_tR and output pulse amplitude I_AR. Duration I_tR and/or amplitude I_AR of reflected output pulse shape 15 change(s) in response to the reflection at locations experiencing rising temperature inside feeder cable 11. The temperature is able to be inferred by comparing output pulse amplitude I_AR to reference pulse amplitude I_A and/or by comparing reference pulse duration I_t to output pulse duration I_At. If the comparison of the pulse durations and/or the pulse amplitudes of reflected output pulse 15 and reference pulse 16 indicates that a defined temperature range is exceeded within the charge process, then the charging current is reduced.

FIG. 3 schematically shows, as another example, a possible reference pulse spectrum 30 plotted over the frequency and a possible output pulse spectrum 31 of the reflected electromagnetic output pulse of the exemplary embodiment of the present invention shown in FIG. 1. Reference pulse 16 has a reference pulse spectrum 30. Reflected output pulse shape 22 has an output pulse spectrum 31. Input pulse 14 coupled into feeder cable 10 is able to be reflected in feeder cable 10. The reflected portion returns to charging device 11 as reflected electromagnetic output pulse 15. The reflection of input pulse 14 in feeder cable 10 may take place at locations where high temperatures exist, which cause a rise in the Ohmic resistance of feeder cable 10. The temperature change is a result of excessive current intensities in feeder cable 10. At the beginning of the charge process feeder cable 10 has a temperature that poses no fire or injury hazard. In this case, the pulse shape of one of the first suitable reflected electromagnetic output pulses 15 is stored in charging device 11 as reference pulse shape 16. This reference pulse shape 16 is utilized to determine reference pulse spectrum 30 in evaluation electronics 13 and is likewise stored in the charging device. In the course of the charging process, output pulse spectrum 31 is determined from the reflected electromagnetic output pulse 15 arriving in charging device 11. Output pulse spectrum 31 of reflected output pulse shape 15 changes in response to the reflection at locations with rising temperature in feeder cable 11. The temperature change is able to be inferred from a comparison of output pulse spectrum 31 and reference pulse spectrum 30. If the comparison of the spectrums of reflected output pulse 15 and reference pulse 16 indicates that a defined temperature range is exceeded within the charge process, then the charging current is reduced.

1-10. (canceled)

11. A method for determining a temperature change of a feeder cable of a charging device, which includes an electronics system for generating an electromagnetic input pulse and evaluation electronics for determining a pulse shape, the method comprising:
coupling the electromagnetic input pulse into the feeder cable, the electromagnetic input pulse being able to be reflected in the feeder cable and the reflected portion returning to the charging device as a reflected electromagnetic output pulse;
determining the pulse shape of the reflected electromagnetic output pulse;
comparing the pulse shape of the reflected electromagnetic output pulse to a reference pulse shape of the reflected reference pulse; and
determining a temperature change from the comparison of the two pulse shapes.

12. The method of claim 11, wherein at a predefined instant of a charging process, the pulse shape of the reflected electromagnetic output pulse is stored in the charging device as a reference pulse shape.

13. The method of claim 12, wherein the predefined instant of the charging process corresponds to a start of the charging process.

14. The method of claim 11, wherein at least one of a pulse duration, a pulse amplitude, and a spectrum obtained from a spectral analysis is used as a measure for the pulse shape.

15. The method of claim 11, wherein the reference pulse shape at the beginning of the charging process is assigned to the temperature of the feeder cable.

16. The method of claim 11, wherein the electromagnetic input pulse has a low energy.

17. The method of claim 11, wherein a low-energy electromagnetic input pulse has a voltage of 30 V or less.

18. The method of claim 11, wherein the in-coupling of the input pulses into the feeder cable takes place in chronological order such that the input pulse is allocatable to the reflected output pulse.

19. The method of claim 11, wherein the charging current is reduced if a defined temperature range is exceeded.

20. A charging device for charging an electrical vehicle, comprising:
an electronics system for generating an electromagnetic input pulse, wherein the electromagnetic input pulse is coupled into the feeder cable, and wherein the electromagnetic input pulse is able to be reflected in the feeder cable, the reflected portion returning to the charging device as a reflected electromagnetic output pulse; and
evaluation electronics for determining a pulse shape by performing the following:
determining the pulse shape of the reflected electromagnetic output pulse;
comparing the pulse shape of the reflected electromagnetic output pulse to a reference pulse shape of the reflected reference pulse; and
determining a temperature change from the comparison of the two pulse shapes.
